(19) United States
(12) Patent Application Publication
(10) Pub. No.: US 2015/0219971 A1
(43) Pub. Date: Aug. 6, 2015

(54) LIQUID CRYSTAL DISPLAY

(71) Applicant: Sharp Kabushiki Kaisha, Osaka-shi (JP)

(72) Inventors: Kohhei Tanaka, Osaka-shi (JP); Hidefumi Yoshida, Osaka-shi (JP); Kazutoshi Kida, Osaka-shi (JP); Yuhji Yashiro, Osaka-shi (JP); Yasuhiro Sugita, Osaka-shi (JP); Hiroyuki Ogawa, Osaka-shi (JP)

(21) Appl. No.: 14/419,309

(22) PCT Filed: Aug. 7, 2013
(86) PCT No.: PCT/JP2013/071329

§ 371 Date: Feb. 3, 2015

(30) Foreign Application Priority Data
Aug. 9, 2012 (JP) 2012-177578

(51) Int. Cl. G02F 1/1343; G02F 1/1333; G06F 3/044; G02F 1/1362

(52) U.S. Cl. CPC G02F 1/134336; G02F 1/1362; G02F 1/13338; G06F 3/044; G02F 2001/13606

(57) ABSTRACT

A liquid crystal display device equipped with in-cell touch panel functionality is configured to increase location determining performance by reducing a parasitic capacitance formed between drive electrodes and a counter electrode. A liquid crystal display device 1 equipped with touch panel functionality is configured such that (i) an active matrix substrate 4 includes pixel electrodes 43, (ii) a counter substrate 5 includes a counter electrode 16, drive electrodes 13, and detection electrodes 12, and (iii) the counter electrode 16 is provided with slits 16s for alignment control.

### TECHNICAL FIELD

The present invention relates to a liquid crystal display device equipped with in-cell touch panel functionality.

### BACKGROUND ART

Conventionally, display devices equipped with touch panels have been put to widespread use. In recent years, display devices equipped with in-cell touch panels (touch panels embedded in display panels) have been introduced (hereinafter, such a display device will also be referred to simply as “display device”) for the purpose of reducing thickness and weight, improving viewability, reducing the number of components for costs reduction, and the like (see, for example, Patent Literature 1).

FIG. 13 is a cross-sectional view schematically illustrating a configuration of a display device disclosed in Patent Literature 1. FIG. 14 is a plan view illustrating a configuration of sensor electrodes taken along the line A-B illustrated in FIG. 13.

As illustrated in FIG. 13, a display device 300 disclosed in Patent Literature 1 includes a display panel 304 in which a liquid crystal layer 303 is sandwiched between a TFT substrate 301 and a CF substrate 302.

A CF layer 318, which includes light shielding parts 316 (BM) and a plurality of colored layers 317 (CF) provided between adjacent light shielding parts 316, is provided between an insulating substrate 311 and a counter electrode 319 (common electrode) which are included in the CF substrate 302. Between the CF layer 318 and the insulating substrate 311, first electrode layers 312 and second electrode layers 314 are provided to as sensor electrodes (location determining electrodes). Between the first electrode layers 312 and the second electrode layers 314, an insulating layer 313 is provided.

As illustrated in FIGS. 13 and 14, the first electrode layers 312 each have (i) linear line parts 312a extending in a first direction and (ii) bulging parts 312b each bulging out from a line part 312a. The second electrode layers 314 each have (i) linear line parts 314a extending in a second direction orthogonal to the first direction and (ii) bulging parts 314b each bulging our from a line part 314a.

According to the display device 300, a touch location of a finger or a pen for an input operation (detection target) is determined by detecting a change in capacitance when the detection target touches a display screen (capacitive method). This allows a touch location to be determined with a simple configuration.

### CITATION LIST

### Patent Literature

Patent Literature 1

Japanese Patent Application Publication, Tokukai, No. 2010-72581 (Publication Date: Apr. 2, 2010)

### SUMMARY OF INVENTION

### Technical Problem

According to the display device 300, (i) the second electrode layers 314 and the counter electrode 319 are in close proximity to each other and (ii) the counter electrode 319 is provided as one solid electrode all over the display panel. This causes a large amount of parasitic capacitance to be formed between the second electrode layers 314 and the counter electrode 319, and therefore causes a driving load of the sensor electrodes to be large. Hence, it is not possible to obtain a sufficient S/N ratio (signal-to-noise ratio), and therefore a problem of reduction in detection performance occurs.

FIG. 15 is a view for describing a principle of how a driving load of sensor electrodes becomes large. FIG. 15 illustrates (i) a counter electrode provided as one solid electrode all over a display panel and (ii) drive electrodes and detection electrodes serving as sensor electrodes. According to the configuration thus illustrated, the solid-formed counter electrode and the drive electrodes are in close proximity to each other, and, accordingly, parasitic capacitance between the counter electrode and the drive electrodes becomes large. This results in a load on the drive electrodes, and therefore causes the number of times a signal is integrated for touch detection to be small. Consequently, it is not possible to obtain a sufficient amount of signal.

In addition, capacitance is formed between the drive electrodes and the detection electrodes. This causes lines of electric force as illustrated in FIG. 15 to be formed. In addition, the parasitic capacitance is formed between the drive electrodes and the counter electrode. This causes other lines of electric force as illustrated in FIG. 15 to be formed. The lines of electric force derived from the capacitance become weak due to the lines of electric force derived from the parasitic capacitance. As a result, it is not possible to obtain a sufficient amount of signal.

According to the display device, it is thus impossible to obtain a sufficient amount of signal because of parasitic capacitance. This results in a reduction in an S/N ratio, and therefore causes location determining performance of a touch panel to be reduced. Particularly, if a display device is made large in size, a reduction in S/N ratio becomes significant. This causes a significant reduction in location determining performance of a touch panel.

The present invention has been made in view of the problem, and it is an object of the present invention to provide a liquid crystal display device equipped with in-cell touch panel functionality, the liquid crystal display device being configured to increase location determining performance by reducing a parasitic capacitance formed between drive electrodes and a counter electrode.

### Solution to Problem

In order to attain the object, a liquid crystal display device of the present invention is a liquid crystal display device equipped with touch panel functionality in which specified coordinates of a detection target are determined by a change in capacitance, said liquid crystal display device including: an active matrix substrate; a counter substrate; and a liquid crystal layer sandwiched between the active matrix substrate and the counter substrate, the active matrix substrate including pixel electrodes, the counter substrate including a counter electrode provided so as to face the pixel electrodes and a plurality of drive electrodes and a plurality of detection electrodes configured to determine the specified coordinates, and the counter electrode provided slits configured to control alignment of liquid crystal molecules of the liquid crystal layer.

According to the configuration, the slits for alignment control are provided. This allows a multi-domain mode to be realized. Particularly, since the counter electrode is provided with the slits, (i) a parasitic capacitance formed between the drive electrodes and the counter electrode can be reduced and (ii) lines of electric force formed between the drive electrodes and the detection electrodes can be made relatively strong. This allows a sufficient amount of signal to be obtained, and therefore makes it possible to increase the location determining performance in comparison with the conventional configuration (see FIG. 15).

The liquid crystal display device is preferably configured such that lines of electric force formed between the plurality of drive electrodes and the plurality of detection electrodes are higher in density than lines of electric force formed between the plurality of drive electrodes and the counter electrode.

The liquid crystal display device can be configured such that the slits are arranged in a concentric pattern expanding from a center part of each of pixels toward end parts of said each of the pixels.

The liquid crystal display device can be configured such that the slits are arranged in a radial pattern extending from a center part of each of pixels toward end parts of said each of the pixels.

The liquid crystal display device is preferably configured such that a plurality of domains are formed in each of pixels.

The liquid crystal display device can be configured to further include: drive electrodes-specified auxiliary wires electrically connected to the plurality of drive electrodes; and detection electrodes-specified auxiliary wires electrically connected to the plurality of detection electrodes, the drive electrodes-specified auxiliary wires and the detection electrodes-specified auxiliary wires being provided so as to overlap boundaries of the plurality of domains when the liquid crystal display device is viewed two-dimensionally.

With the configuration, it is possible to reduce wire resistance of the drive electrodes and the detection electrodes.

The liquid crystal display device is preferably configured such that: the plurality of drive electrodes are arranged in a row direction and a column direction; the plurality of detection electrodes are arranged in the row direction and the column direction; and the plurality of drive electrodes and the plurality of detection electrodes are alternated in diagonal directions.

In order to attain the object, a liquid crystal display device of the present invention is a liquid crystal display device equipped with touch panel functionality in which specified coordinates of a detection target are determined by a change in capacitance, said liquid crystal display device comprising: an active matrix substrate; a counter substrate; and a liquid crystal layer sandwiched between the active matrix substrate and the counter substrate, the active matrix substrate including pixel electrodes, the counter substrate including a counter electrode provided so as to face the pixel electrodes and a plurality of drive electrodes and a plurality of detection electrodes configured to determine the specified coordinates, and the counter substrate provided with slits such that lines of electric force formed between the plurality of drive electrodes and the plurality of detection electrodes are higher in density than lines of electric force formed between the plurality of drive electrodes and the counter electrode.

### Advantageous Effects of Invention

As has been described, the liquid crystal display device of the present invention is configured such that the counter electrode is provided with slits configured to control alignment of liquid crystal molecules of the liquid crystal layer. This allows a liquid crystal display device equipped with in-cell touch panel functionality to increase location determining performance while reducing a parasitic capacitance to be formed between drive electrodes and a counter electrode.

### BRIEF DESCRIPTION OF DRAWINGS

FIG. 1 is a cross-sectional view schematically illustrating a configuration of a liquid crystal display device in accordance with an embodiment (Example 1) of the present invention.

FIG. 2 is a plan view illustrating part of a counter substrate of the liquid crystal display device in accordance with Example 1.

FIG. 3 is a plan view illustrating a wide area of the counter substrate of the liquid crystal display device in accordance with Example 1.

FIG. 4 is a set of views illustrating a capacitive method-based touch panel, (a) of FIG. 4 being a plan view for describing a configuration of electrodes of a touch panel, (b) of FIG. 4 being a cross-sectional view taken along the line A-B illustrated in (a) of FIG. 4, and (c) of FIG. 4 being a view for describing how the touch panel operates when a finger touches the touch panel.

FIG. 5 is a cross-sectional view schematically illustrating how lines of electric force are formed between the counter electrode and location determining electrodes according to the liquid crystal display device of Example 1.

FIG. 6 is a plan view illustrating part of a counter substrate in accordance with a modification of Example 1.

FIG. 7 is a cross-sectional view taken along the line A-B illustrated in FIG. 6.

FIG. 8 is a plan view illustrating a wide area of the counter substrate in accordance with the modification of Example 1.

FIG. 9 is a plan view illustrating part of a counter substrate of a liquid crystal display device in accordance with Example 2.

FIG. 10 is a plan view illustrating a wide area of the counter substrate in accordance with Example 2.

FIG. 11 is a plan view illustrating part of a counter substrate in accordance with a modification of Example 2.

FIG. 12 is a plan view illustrating a wide area of the counter substrate in accordance with Example 2.

FIG. 13 is a cross-sectional view schematically illustrating a configuration of a display device disclosed in Patent Literature 1.

FIG. 14 is a plan view illustrating a configuration of sensor electrodes taken along the line A-B illustrated in FIG. 13.

FIG. 15 is a view for describing a principle of how a driving load of sensor electrodes becomes large.

### DESCRIPTION OF EMBODIMENTS

The following description will discuss an embodiment of a liquid crystal display device of the present invention, which is equipped with in-cell touch panel functionality (hereinafter referred to simply as “liquid crystal display device”).

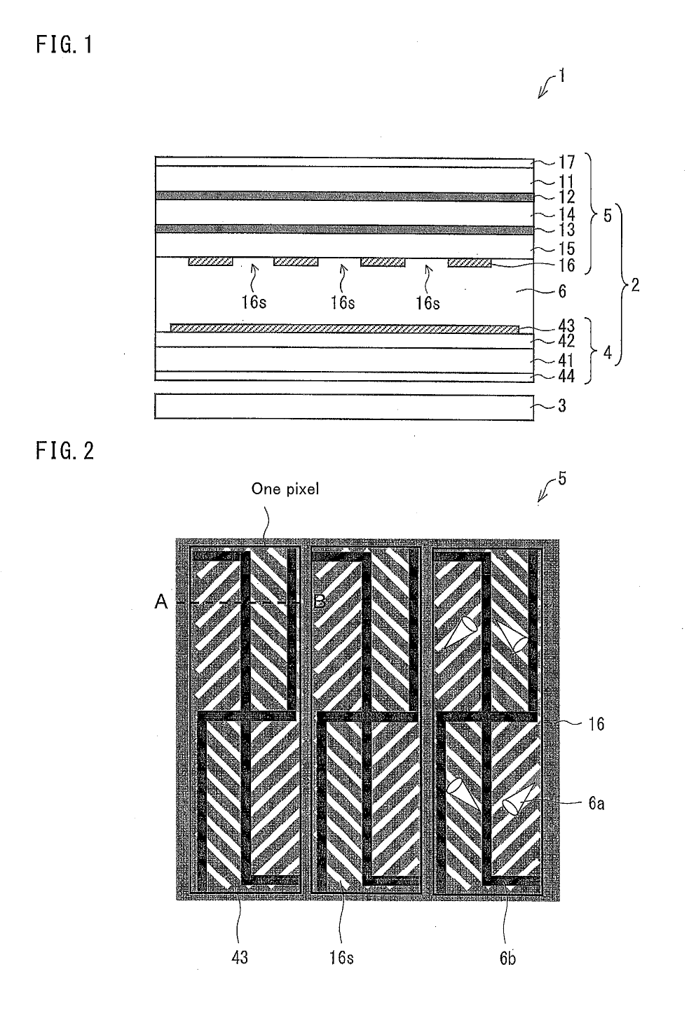

FIG. 1 a cross-sectional view schematically illustrating a configuration of a liquid crystal display device in accordance with the present embodiment. A liquid crystal display device 1 illustrated in FIG. 1 includes (i) a liquid crystal panel 2 equipped with normal image display functionality and with touch panel functionality by use of the capacitive method, (ii) various drive circuits (data signal line drive circuit, scan signal line drive circuit, and the like; not illustrated) for driving the liquid crystal panel 2, and (iii) a backlight 3 for illuminating the liquid crystal panel 2.

The liquid crystal panel 2 is an active matrix display panel in which a liquid crystal layer 6 is sandwiched between a pair of substrates (an active matrix substrate 4 (TFT substrate) and a counter substrate 5 (color filter (CF) substrate)). According to the liquid crystal panel 2, (i) the counter substrate 5 faces an observer (detection target) and (ii) the backlight 3 is provided to face a back surface of the active matrix substrate 4.

The active matrix substrate 4 includes a glass substrate 41, and includes, on the glass substrate 41, (i) various signal lines such as scan signal lines and data signal lines (not illustrated), (ii) transistors (TFTs) (not illustrated), (iii) an insulating film 42, (iv) pixel electrodes 43 corresponding to respective pixels provided in a matrix, and (v) a polarizing plate 44. The active matrix substrate 4 can have a well-known configuration.

The counter substrate 5 has a configuration for realizing image display functionality and a configuration for realizing touch panel functionality. An example of a specific configuration of the counter substrate 5 will be mainly discussed below.

### Example 1

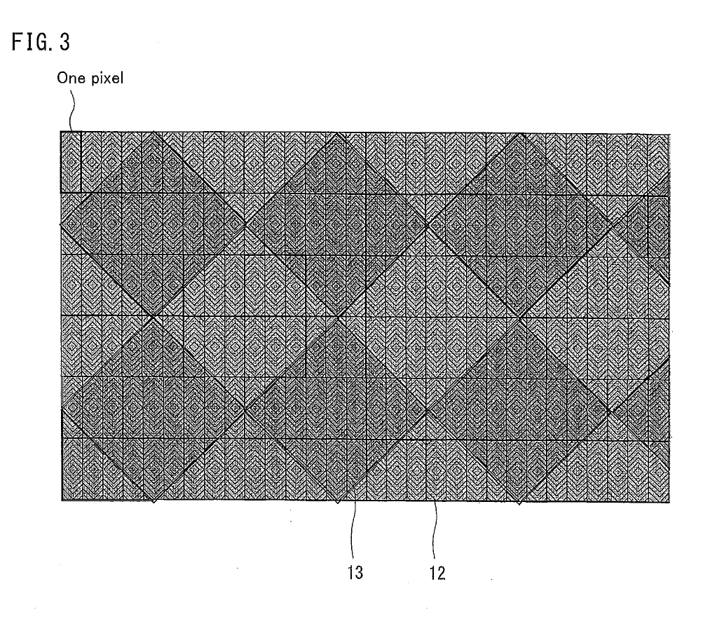

A liquid crystal display device in accordance with Example 1 is configured as illustrated in FIG. 1. FIG. 2 is a plan view illustrating part of a counter substrate 5 of Example 1. FIG. 1 is a cross-sectional view taken along the line A-B illustrated in FIG. 2. FIG. 3 illustrates a wide area of the counter substrate 5 of Example 1. FIG. 2 illustrates a part corresponding to three pixels. Note, however, that a pixel structure is not limited to such a configuration, but can be configured such that a single pixel is made up of three sub-pixels (R sub-pixel, G sub-pixel, and B sub-pixel) and that FIG. 2 is assumed to illustrate such a single pixel. Alternatively, each pixel can include a plurality of pixel electrodes to have a pixel-partitioned structure.

The counter substrate 5 includes (i) a glass substrate 11, (ii) a plurality of detection electrodes 12 and a plurality of drive electrodes 13 serving as location determining electrodes (sensor electrodes), (iii) a first insulating film 14, (iv) a second insulating film 15, (v) a black matrix (not illustrated), (vi) a color filter layer (not illustrated), (vii) a counter electrode 16, and (viii) a polarizing plate 17.

When the liquid crystal panel 2 is viewed two-dimensionally as illustrated in FIG. 3, (i) the detection electrodes 12 (parts shown in light gray color) are arranged in a row direction and a column direction, (ii) the drive electrodes 13 (parts shown in dark gray color) are arranged in the row direction and the column direction, and (iii) the detection electrodes 12 and the drive electrodes 13 are alternated in diagonal directions. For convenience, FIG. 1 does not illustrate such patterning of the detection electrodes 12 and the drive electrodes 13.

The detection electrodes 12 and the drive electrodes 13 are transparent, and are each made of, for example, a transparent conductive material such as an oxide. Examples of the transparent conductive material encompass ITO (indium tin oxide), IZO (indium zinc oxide), zinc oxide, and tin oxide. Alternatively, the detection electrodes 12 and the drive electrodes 13 can each be transparent as a result of being a thin electrode. Examples of the thin electrode encompass (i) a metal thin-film electrode such as graphene and (ii) a thin-film carbon electrode.

FIG. 1 illustrates the detection electrodes 12 and the drive electrodes 13 as two independent layers. Note, however, that the detection electrodes 12 and the drive electrodes 13 are not limited to such a configuration, but can be a single layer. In such a case, either detection electrodes 12 or drive electrodes 13 are connected to one another by bridge connection. Alternatively, how the detection electrodes 12 are arranged and how the drive electrodes 13 are arranged can be interchanged.

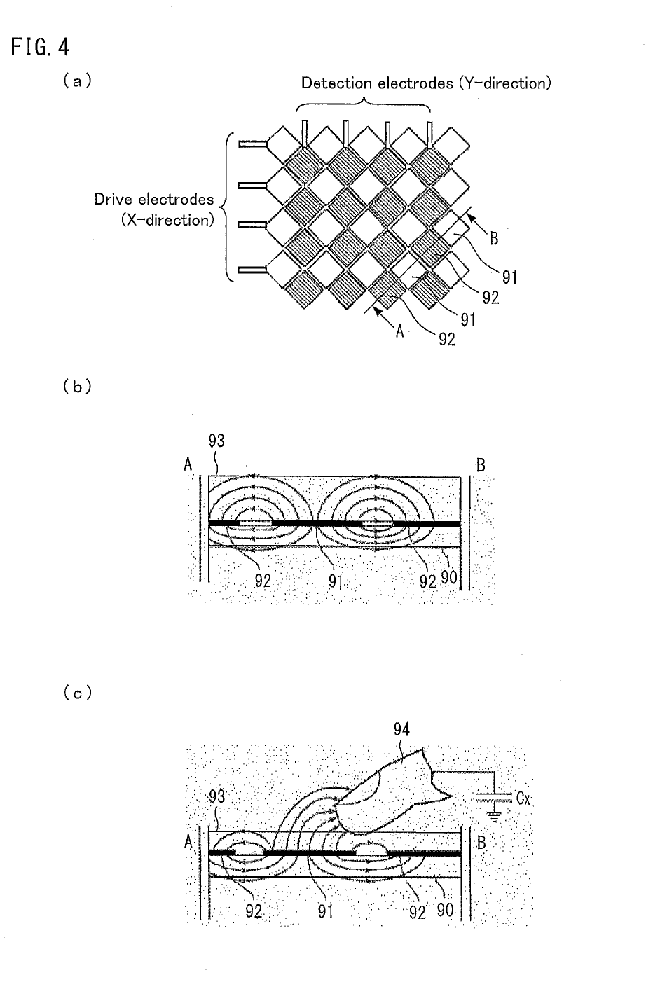

The detection electrodes 12 and the drive electrodes 13 allow the capacitive-method touch panel functionality to be realized. An operating principle of a capacitive method-based touch panel will be described below with reference to FIG. 4.

FIG. 4 schematically illustrates a capacitive method-based touch panel. (a) of FIG. 4 is a plan view for describing a configuration of electrodes of the touch panel. (b) of FIG. 4 is a cross-sectional view taken along the line A-B illustrated in (a) of FIG. 4. (c) of FIG. 4 is a cross-sectional view for describing how the touch panel operates when a finer (detection target) touches the touch panel. Note that FIG. 4 illustrates a configuration in which detection electrodes and drive electrodes are provided in a single layer.

In FIG. 4, the reference sign, 90, indicates a substrate made of a transparent insulator (dielectric). On one surface of the substrate 90, a plurality of drive electrodes 91 and a plurality of detection electrodes 92 are provided. A cover glass 93 is provided so as to cover the surface on which the drive electrodes 91 and the detection electrodes 92 are provided. The cover glass 93 is made of an insulator, such as transparent glass, which has predetermined dielectric constant.

In (a) of FIG. 4, drive electrodes 91 of respective columns are connected to one another in an X-axis direction, and detection electrodes 92 of respective rows are connected to one another in a Y-axis direction. Either the drive electrodes 91 or the detection electrodes 92 are connected to one another by bridge connection. In a case where a drive voltage is applied across the drive electrodes 91 and the detection electrodes 92, a capacitance is formed between the drive electrodes 91 and the detection electrodes 92 via the substrate 90 and the cover glass 93, so that lines of electric force as illustrated in (b) of FIG. 4 are formed.

In so doing, when a fingertip 94 touches a front surface of the cover glass 93 as illustrated in (c) of FIG. 4, a capacitance Cx is formed between the touch panel and the ground via a human body, so that part of the lines of electric force is grounded via the fingertip 94. This indicates that a capacitance between part of the drive electrodes 91 and part of the detection electrodes 92, which parts correspond to a location touched by the fingertip 94, is changed by a large amount. By determining such an amount of the change, the location touched by the fingertip 94 can be determined.

A capacitive-based location determining method is not limited to the above method, but can be a well-known method. That is, it is possible to employ a mutual capacitive method-based touch panel or a self-capacitive method-based touch panel.

A configuration of the counter electrode 16 will be described below with reference to FIG. 2.

The counter electrode 16 is provided with a plurality of slits 16s configured to control alignment of liquid crystal molecules 6a of the liquid crystal layer 6. Specifically, when viewed two-dimensionally, the slits 16s are arranged in a concentric pattern expanding from a center part of each pixel toward end parts of the pixel.

Optical alignment process provides tilt angles to liquid crystal molecules 6a in the vicinity of the pixel electrodes 43 and the counter electrode 16. In so doing, application of a voltage causes the liquid crystal molecules 6a to be aligned in a spiral pattern (concentric pattern), so that four domains are formed in each of the pixels. In the present example, domain boundaries 6b each having a swastika shape are formed. A multi-domain RTN-mode liquid crystal panel is thus realized. Note that the slits 16s are formed so as to increase an alignment force of the liquid crystal molecules 6a by patterning the counter electrode 16, and that it is possible to adapt the slits 16s to different liquid crystal modes such as 4-domain mode, 2-domain mode, and mono-domain mode.

Note that according to a conventional liquid crystal display device in which a counter electrode is provided with no slits, a large parasitic capacitance is formed between the counter electrode and drive electrodes. This causes a load on the drive electrodes to be large. In a case of a large panel, particularly, it is not possible to secure a sufficient S/N ratio, and therefore location determining performance is reduced. With a conventional configuration in which pixel electrodes are provided with slits for alignment control, it is also not possible to solve the problem of decreased location determining performance, although a multi-domain mode can be realized.

Meanwhile, with the liquid crystal display device 1 of Example 1, not only is it possible to realize a multi-domain mode because of the counter electrode 16 having the slits 16s, it is also possible to bring about the following effects.

Since it is possible to increase an alignment control force, the alignment of the liquid crystal molecules 6a can be stabilized. In addition, since a voltage threshold for driving liquid crystal molecules 6a in a region where the slits 16s are provided and a voltage threshold for driving liquid crystal molecules 6a in a region where the slits 16s are not provided are made different from each other, it is possible to realize a wide viewing angle.

Furthermore, since it is possible to cause an effective area of the counter electrode 16 (i.e. the area of the counter electrode 16 excluding areas of the slits 16s) to be small, it is possible to cause a parasitic capacitance between the counter electrode 16 and the drive electrodes 13 to be small. This allows a load on the drive electrodes 13 to be small, and therefore allows the number of times a signal is integrated for touch detection to be increased.

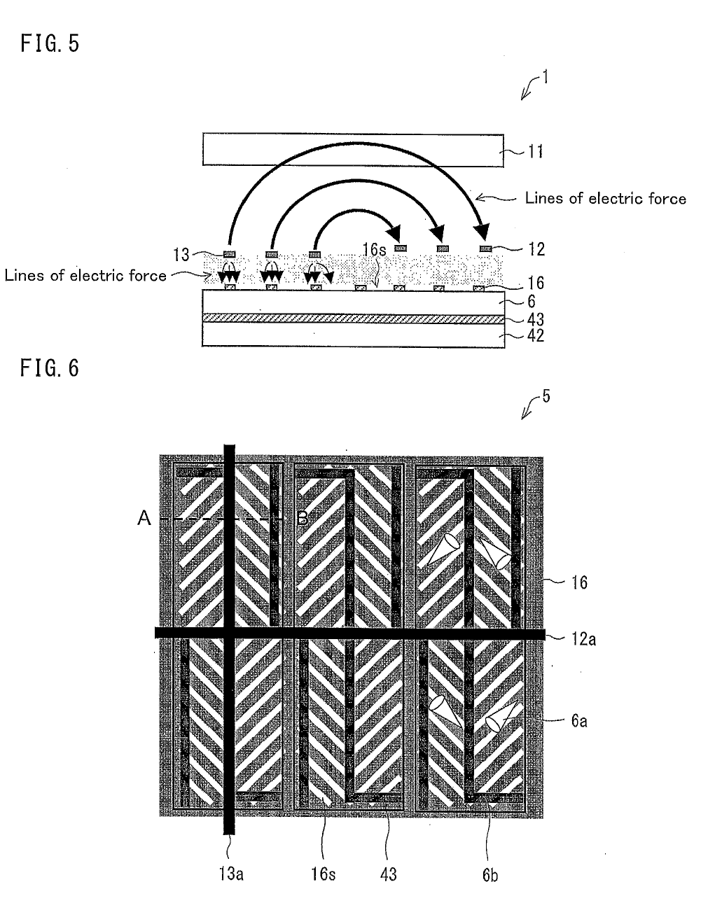

FIG. 5 is a cross-sectional view schematically illustrating how lines of electric force are formed between the counter electrode 16 and the location determining electrodes (the detection electrodes 12 and the drive electrodes 13). As illustrated in FIG. 5, the counter electrode 16 is provided with slits 16s. This causes density of lines of electric force formed between the drive electrodes 13 and the detection electrodes 12 to be higher than density of lines of electric force formed between the drive electrodes 13 and the counter electrode 16. In other words, the lines of electric force formed between the detection electrodes 12 and the drive electrodes 13 can be made relatively strong.

With the configuration, a sufficient amount of signal can be obtained. Therefore, it is possible to increase the location determining performance of a touch panel in comparison with the conventional configuration (see FIG. 15). This restricts a reduction in S/N ratio, and therefore allows a liquid crystal panel to be large in size.

Note that a total surface area of the slits 16s is preferably equal to or more than 30% of a total surface area of a display region through which light passes. A width (breadth) of each of the slits 16s is preferably equal to or less than 5 μm.

### Modification of Example 1

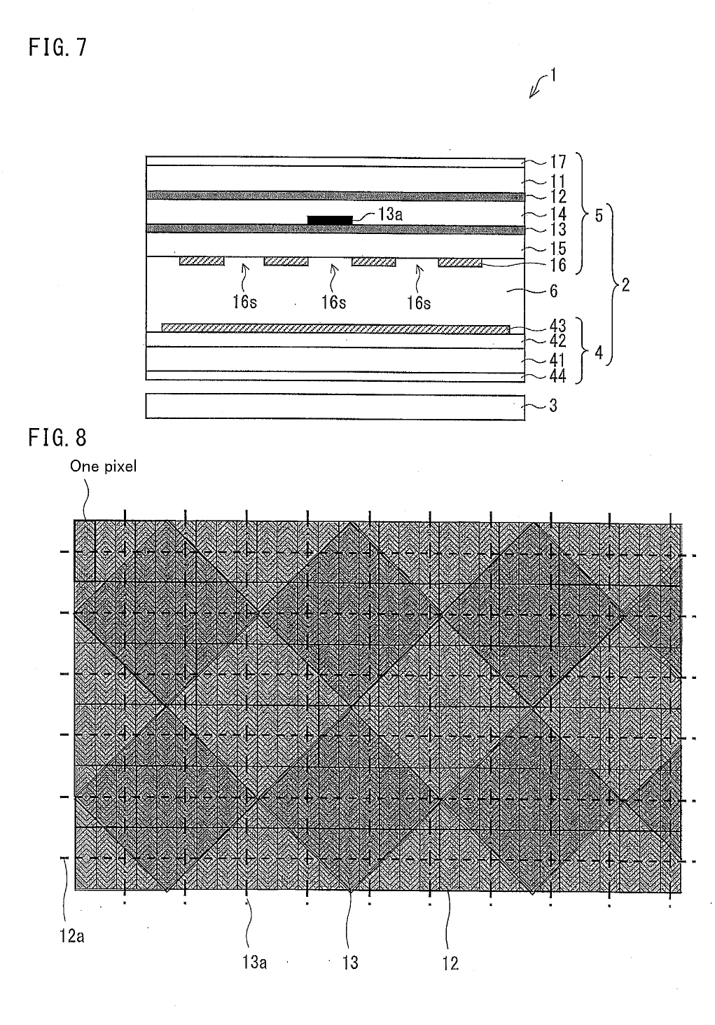

FIG. 6 is a plan view illustrating part of a counter substrate 5 in accordance with a modification of Example 1. FIG. 7 is a cross-sectional view taken along the line A-B illustrated in FIG. 6. FIG. 8 illustrates a wide area of the counter substrate 5 of the present modification.

The counter substrate 5 of the liquid crystal display device 1 in accordance with the present modification is configured by further providing detection electrodes-specified auxiliary wires 12a and drive electrodes-specified auxiliary wires 13a to the counter substrate 5 illustrated in FIG. 1. The detection electrodes-specified auxiliary wires 12a are electrically connected to detection electrodes 12 while the drive electrodes-specified auxiliary wires 13a are electrically connected to drive electrodes 12.

When a liquid crystal panel 2 is viewed two-dimensionally, the detection electrodes-specified auxiliary wires 12a and the drive electrodes-specified auxiliary wires 13a are provided so as to overlap dark lines that occur at domain boundaries 6b (see FIG. 7). This makes it possible to reduce, while restricting a reduction in transmissivity, wire resistance of the detection electrodes 12 and the drive electrodes 13.

Assume a case where slits are provided on a pixel-electrode side of an active matrix substrate as is the case of a conventional technology. In such a case, if incorrect positioning occurs in a substrate combining step of combining substrates together, then positions of drive electrodes-specified auxiliary wires and detection electrodes-specified auxiliary wires provided on a counter-substrate side are out of alignment in relation to positions of dark lines on an active-matrix-substrate side. This causes a significant reduction in transmissivity.

In contrast, according to the liquid crystal display device 1 in which slits 16s and the auxiliary wires 12a and 13a are commonly provided on the counter substrate 5, positions of the dark lines and positions of the auxiliary wires 12a and 13a are unlikely to be out of alignment in relation to each other. This allows the reduction in transmissivity due to incorrect positioning during a substrate combining step to be restricted.

According to the present modification, each of the drive electrodes-specified auxiliary wires 13a is provided for every three pixels as illustrated in FIGS. 6 and 8. However, the present modification is not limited to such a configuration. In fact, each of the drive electrodes-specified auxiliary wires 13a can be provided for every pixel. Alternatively, the auxiliary wires 12a and 13a can be provided on a BM (black matrix) laid out between pixels.

By thus providing the auxiliary wires 12a and 13a, it is possible to reduce the wire resistance of the detection electrodes 12 and the drive electrodes 13. This allows a load on the drive electrodes 13 to be further reduced.

### Example 2

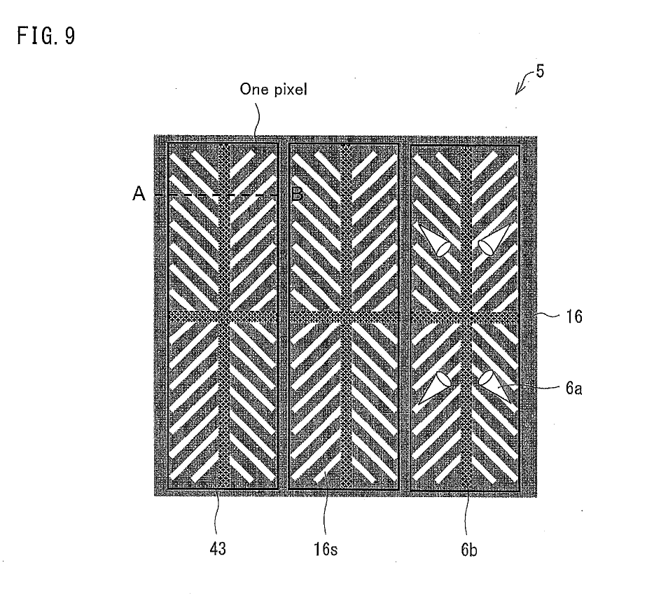

FIG. 9 is a plan view illustrating part of a counter substrate 5 of a liquid crystal display device 1 in accordance with Example 2. Note that a cross-sectional view taken along the line A-B illustrated in FIG. 9 is identical to FIG. 1. FIG. 10 illustrates a wide area of the counter substrate 5 in accordance with Example 2.

As illustrated in FIGS. 9 and 10, the counter substrate 5 of Example 2 is identical in configuration to the counter substrate 5 of Example 1 (see FIGS. 2 and 3) except for shapes of slits 16s and shapes of domain boundaries 6b.

The slits 16s of Example 2 are formed in a radial pattern extending from a center part of each pixel to ends parts of the pixel. The domain boundaries 6b are formed in a cross shape passing through center parts of the pixels and extending in a row direction and a column direction.

According to the configuration of Example 2, (i) liquid crystal molecules 6a in the vicinity of pixel electrodes 43 and a counter electrode 16 are given tilt angles and (ii) application of a voltage causes the liquid crystal molecules 6a to be aligned in a radial pattern, so that four domains are formed in each of the pixels. This allows the liquid crystal display device 1 of Example 2 to produce an advantageous effect identical to that produced by the liquid crystal display device 1 of Example 1.

### Modification of Example 2

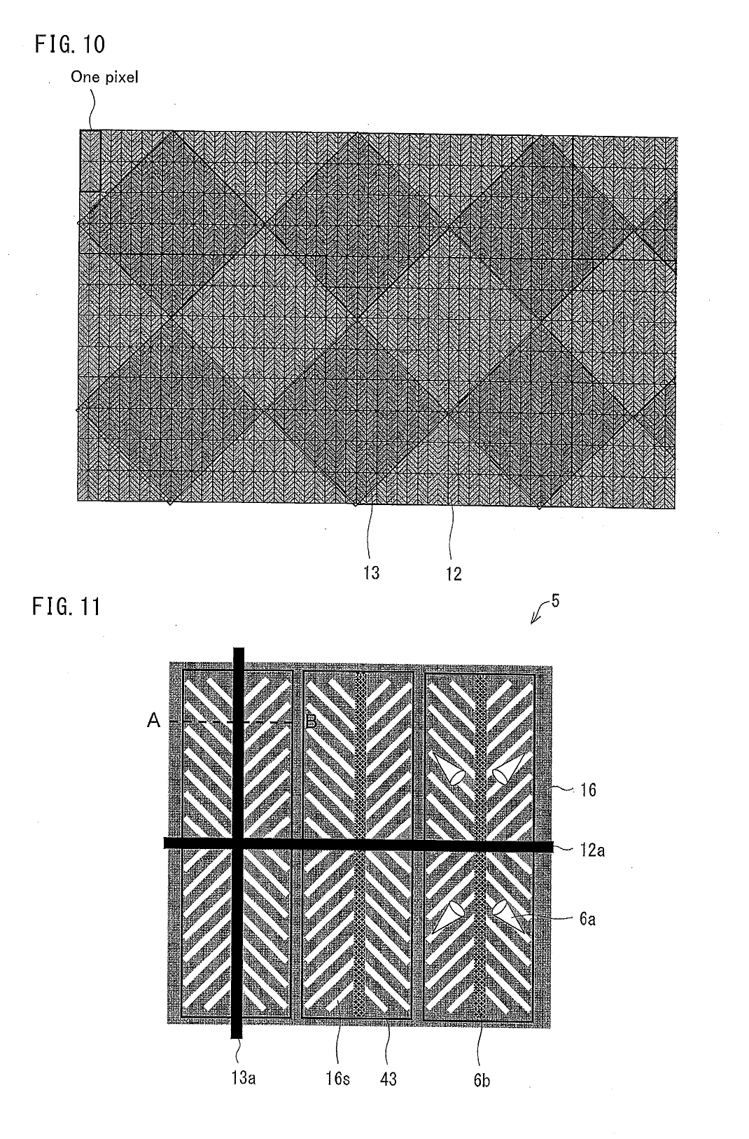

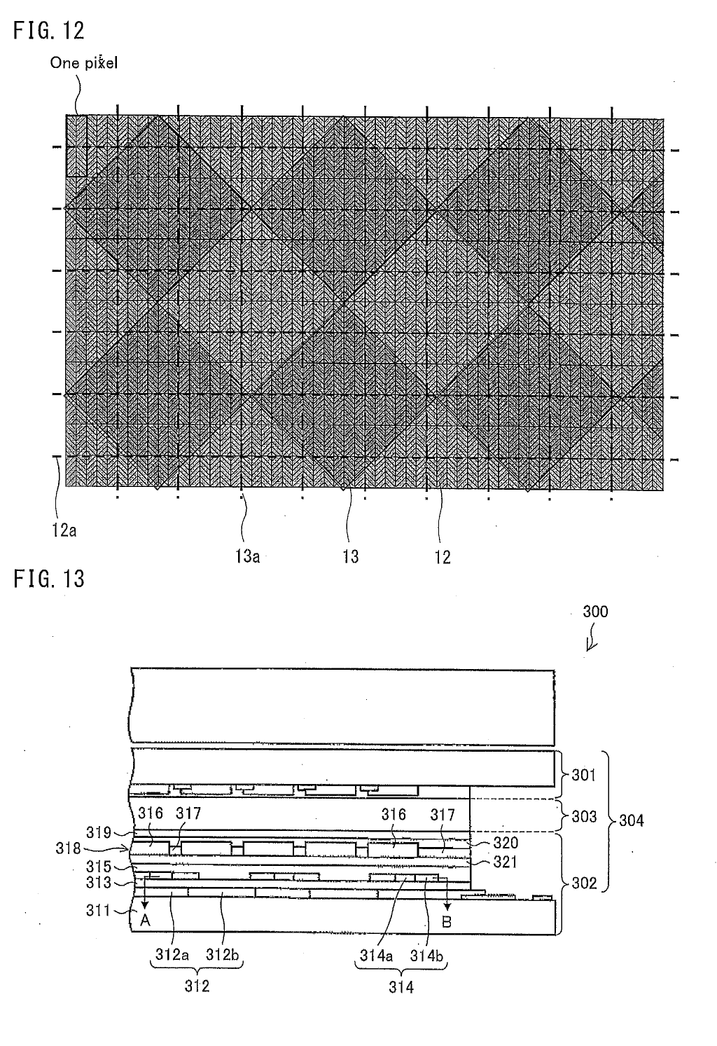

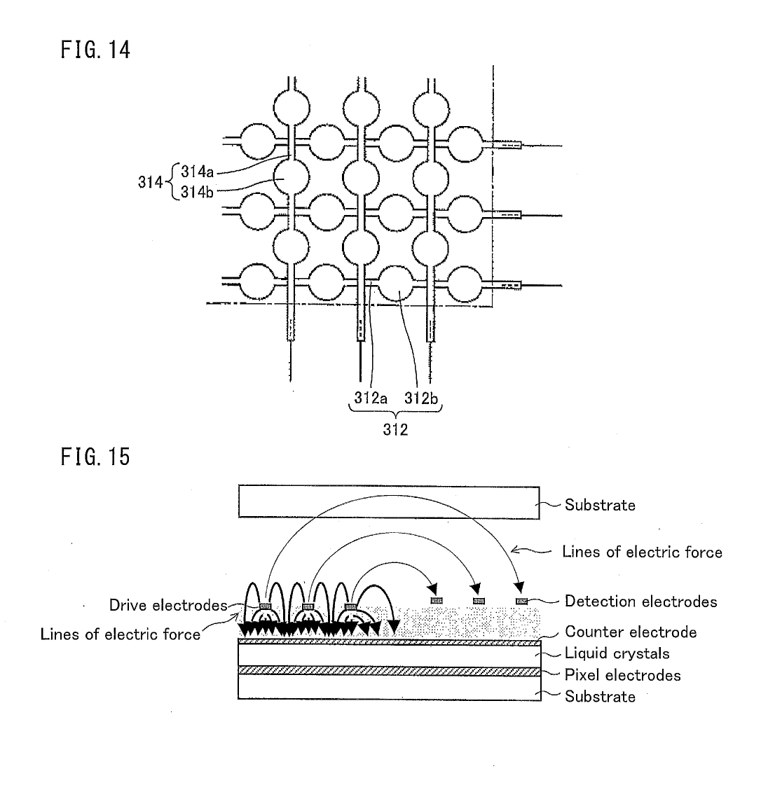

FIG. 11 is a plan view illustrating part of a counter substrate 5 in accordance with a modification of Example 2. Note that a cross-sectional view taken along the line A-B illustrated in FIG. 11 is identical to FIG. 7. FIG. 12 illustrates a wide area of the counter substrate 5 in accordance with the modification of Example 2.

The counter substrate 5 of a liquid crystal display device 1 in accordance with the present modification is configured by further providing detection electrodes-specified auxiliary wires 12a and drive electrodes-specified auxiliary wires 13a to the counter substrate 5 illustrated in FIG. 9. Specifically, the detection electrodes-specified auxiliary wires 12a and the drive electrodes-specified auxiliary wires 13a are provided on dark lines that occur at domain boundaries 6b. This, as is the case of the liquid crystal display device 1 in accordance with the modification of Example 1, makes it possible to reduce, while restricting a reduction in transmissivity, wire resistance of detection electrodes 12 and drive electrodes 13.

According to the present modification, each of the drive electrodes-specified auxiliary wires 13a is provided for every three pixels as illustrated in FIGS. 11 and 12. However, the present modification is not limited to such a configuration. In fact, each of the drive electrodes-specified auxiliary wires 13a can be provided for every pixel. Alternatively, the auxiliary wires 12a and 13a can be provided on a BM (black matrix) laid out between pixels.

By thus providing the auxiliary wires 12a and 13a, it is possible to reduce the wire resistance of the detection electrodes 12 and the drive electrodes 13. This allows a load on the drive electrodes 13 to be further reduced.

The present invention is not limited to the description of the embodiments, but can be altered in many ways by a person skilled in the art within the scope of the claims. An embodiment derived from a proper combination of technical means disclosed in different embodiments is also encompassed in the technical scope of the present invention.

### INDUSTRIAL APPLICABILITY

A liquid crystal display device equipped with touch panel functionality of the present invention is suitable for various mobile devices, large displays, and the like.

### REFERENCE SIGNS LIST

1 Liquid crystal display device
2 Liquid crystal panel
3 Backlight
4 Active matrix substrate
5 Counter substrate
6 Liquid crystal layer
6a Liquid crystal molecule
6b Domain boundary
11 Glass substrate
12 Detection electrode (location determining electrode)
12a Detection electrodes-specified auxiliary wire
13 Drive electrode (location determining electrode)
13a Drive electrodes-specified auxiliary wire
14 First insulating film
15 Second insulating film
16 Counter electrode
16s Slit
17 Polarizing plate
41 Glass substrate
42 Insulating film
43 Pixel electrode

1. A liquid crystal display device equipped with touch panel functionality in which specified coordinates of a detection target are determined by a change in capacitance,
said liquid crystal display device comprising:
an active matrix substrate;
a counter substrate; and
a liquid crystal layer sandwiched between the active matrix substrate and the counter substrate,
the active matrix substrate including pixel electrodes,
the counter substrate including
a counter electrode provided so as to face the pixel electrodes and
a plurality of drive electrodes and a plurality of detection electrodes configured to determine the specified coordinates, and
the counter electrode provided with slits configured to control alignment of liquid crystal molecules of the liquid crystal layer.

2. The liquid crystal display device as set forth in claim 1, wherein
lines of electric force formed between the plurality of drive electrodes and the plurality of detection electrodes are higher in density than lines of electric force formed between the plurality of drive electrodes and the counter electrode.

3. The liquid crystal display device as set forth in claim 1, wherein
the slits are arranged in a concentric pattern expanding from a center part of each of pixels toward end parts of said each of the pixels.

4. The liquid crystal display device as set forth in claim 1, wherein
the slits are arranged in a radial pattern extending from a center part of each of pixels toward end parts of said each of the pixels.

5-6. (canceled)

7. The liquid crystal display device as set forth in claim 2, wherein:
the plurality of drive electrodes are arranged in a row direction and a column direction;
the plurality of detection electrodes are arranged in the row direction and the column direction; and
the plurality of drive electrodes and the plurality of detection electrodes are alternated in diagonal directions.

8. A liquid crystal display device equipped with touch panel functionality in which specified coordinates of a detection target are determined by a change in capacitance,
said liquid crystal display device comprising:
an active matrix substrate;
a counter substrate; and
a liquid crystal layer sandwiched between the active matrix substrate and the counter substrate;
the active matrix substrate including pixel electrodes,
the counter substrate including
a counter electrode provided so as to face the pixel electrodes and
a plurality of drive electrodes and a plurality of detection electrodes configured to determine the specified coordinates, and
the counter substrate provided with slits such that lines of electric force formed between the plurality of drive electrodes and the plurality of detection electrodes are higher in density than lines of electric force formed between the plurality of drive electrodes and the counter electrode.
